(19) United States
(12) Patent Application Publication
(10) Pub. No.: US 2018/0157711 A1
(43) Pub. Date: Jun. 7, 2018

(54) METHOD AND APPARATUS FOR PROCESSING QUERY BASED ON HETEROGENEOUS COMPUTING DEVICE

(71) Applicant: ELECTRONICS AND TELECOMMUNICATIONS RESEARCH INSTITUTE, Daejeon (KR)

(72) Inventor: Hun Soon LEE, Daejeon (KR)

(73) Assignee: ELECTRONICS AND TELECOMMUNICATIONS RESEARCH INSTITUTE, Daejeon (KR)

(21) Appl. No.: 15/622,451

(22) Filed: Jun. 14, 2017

(30) Foreign Application Priority Data
Dec. 6, 2016 (KR) 10-2016-0165377

(51) Int. Cl. G06F 17/30

(52) U.S. Cl. CPC G06F 17/30469; G06F 17/30477

(57) ABSTRACT

Disclosed herein are a method and an apparatus for processing a query based on a heterogeneous computing device. The method includes generating, by the apparatus for processing a query, an optimal query execution plan for processing the query using all of a plurality of computation resources included in a heterogeneous computation resource and dividing data corresponding to the query depending on a data division ration included in the query execution plan and allocating the divided data to each computation resource. Further, the divided data are each processed based on each computation resource.

### CROSS-REFERENCE TO RELATED APPLICATION

This application claims priority to and the benefit of Korean Patent Application No. 10-2016-0165377 filed in the Korean Intellectual Property Office on Dec. 6, 2016, the entire contents of which are incorporated herein by reference.

### BACKGROUND OF THE INVENTION

### (a) Field of the Invention

The present invention relates to query processing, and more particularly, to a method and an apparatus for processing a query under computer environment including a heterogeneous computing device.

### (b) Description of the Related Art

In recent years, there is a limitation in increasing a computation speed by increasing a clock speed. Therefore, a central processing unit (CPU) is being developed to use multiple cores. However, CPUs supporting complex operations are optimized for sequential processing, and therefore has a limitation in performing multi-tasking. On the other hand, a graphics processing unit (GPU) that has a simpler function than the CPU but has ability to perform parallel processing at a high speed using thousands of cores is widely used for the purpose of accelerating the performance of a general purpose operation in an apparatus for graphics processing only. The GPU is also referred to as general-purpose computing on GPUs (GPGPUs) because it is not restrictively used for graphics processing but may be used for general purpose.

The recent systems consisting of heterogeneous computing devices including the CPU and the GPGPU have been used in a form in which the GPGPU serves to perform simple but high volume processing under the control of the CPU which is responsible for complex decision-making and resource allocation. Recently, most computers are basically equipped with the GPGPU, and the computing environment including heterogeneous computing devices (CPU, GPGPU, APU, many integrated core (MIC), etc.) has been widely used in various fields.

Conventionally, in query processing of the database management system, a vector processing provided by the CPU or operation offloading to the GPGPU is used for the performance. Further, systems that may perform whole query processings on the GPGPU have emerged one after another in recent years.

However, conventionally, only a portion (CPU or GPU) of the computing devices are used for query processing in the heterogeneous computing environment, which leads to a problem in that a resource utilization of the system is decreased and a load of a specific computing device is increased to make a user response time long and decrease throughput. Therefore, the user satisfaction for the corresponding system may be decreased.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method and an apparatus for processing a query using all the available heterogeneous computing devices at the time of query processing.

An exemplary embodiment of the present invention provides a method for processing, by an apparatus for processing a query, an input query, including: generating, by the apparatus for processing a query, an optimal query execution plan for processing the query using all of a plurality of computation resources included in a heterogeneous computation resource; dividing data corresponding to the query depending on a data division ration included in the query execution plan and allocating the divided data to each computation resource; and processing the divided data based on each computation resource.

The query execution plan may include a computation resource on which an operation is to be executed, an operation execution method, and the data division ratio, for each operation configuring a query and may further include data information to which the operation is to be applied.

The generating of the optimal query execution plan may include: determining a method to execute operation with minimum cost among a plurality of methods which are implemented to use a computation resource available for the operation according to an available computation resource for the plurality of computation resources.

The determining of the operation execution method may include: determining the method to execute operation with minimum cost among the plurality of methods which are implemented to use one computation resource, when the available computation resource is only one; and determining the method to execute operation with minimum cost the plurality of methods which are implemented to use at least two computation resources, when the available computation resource is two or more.

When the available computation resources are CPUs and GPGPUs, the cost may include a time taken to divide data, the larger value of operation cost using the CPU for the data allocated to use the CPU and operation cost using the GPGPU for data allocated to use the GPGPU, and a result merging estimated time taken to merge a result of the operation using the CPU and a result of the operation using the GPGPU.

In the generating of the query execution plan, an optimal query execution plan may be generated in consideration of the division ratio of data to be processed by each computation resource included in the heterogeneous computing environment. The data division ratio may represent a ratio of data to be processed using the CPU in the heterogeneous computing environment among all data.

When the computation resources in the heterogeneous computation environment include the CPU and other computation resources other than the CPU and use all the CPU and the other computation resources, the generating of the query execution plan further may include: obtaining an optimal data division ratio having a minimum operation cost.

The obtaining of the optimal data division ratio may include: a first step of comparing an estimated cost of a first data division ratio and an estimated cost of a second data division ratio, for a search interval consisting of the first data division ratio and the second data division ratio; a second step of shifting a data division ratio having a larger estimated cost toward an intermediate value by a shift value to reduce the search interval, among the first data division ratio and the second data division ratio, as the comparison result; and a third step of obtaining the optimal data division ratio having a minimum operation cost by repeatedly performing the first step and the second step for the reduced search interval.

The shift value may be calculated depending on the following Equation.

Shift value=first data division ratio±(first data division ratio+second data division ratio)/2×r), in which r may represent a reduction ratio, the first data division ratio may represent a data division ratio having a larger estimated operation execution cost among the data division ratios configuring the search interval, and the second data division ratio may represent a data division ratio having a less estimated operation execution cost among the data division ratios configuring the search interval.

The reduction ratio r may have different value for each operation.

The processing may include: executing each of the corresponding computation resource based operations on data allocated to each computation resource of the plurality of computation resources; merging the respective computation resource based operation execution results; and providing the merged operation execution results as a query processing result.

Another embodiment of the present invention provides an apparatus for processing a query, including: an input/output unit configured to receive a query and data corresponding thereto; and a processor connected to the input/output unit and executing the query processing, in which the processor may include: a query optimization module configured to generate an optimal query execution plan for processing the query using all of a plurality of computation resources included in heterogeneous computation environment, the optimal query execution plan including a data division ratio dividing data corresponding to the query and allocating the divided data to each computation resource; an operation providing module configured to provide each of the computation resource based operations; and a query execution module configured to call any computation resource based operation of the operation providing module according to the query execution plan and execute the corresponding operation based on data allocated to the computation resource of the called operation.

The query execution plan may include a computation resource on which an operation is to be executed, an operation execution method, and the data division ratio, for each operation configuring a query and may further include data information to which the operation is to be applied.

The query optimization module may determine a method to execute operation with minimum cost among a plurality of methods which are implemented to use a computation resource available for the operation according to an available computation resource for the plurality of computation resources. The query optimization module may estimate the cost of operation based on a cost model provided by the operation providing module.

When the available computation resource is a CPU, the cost may be an estimated execution time of the operation using the CPU and when the available computation resource is a GPGPU, the cost may include a first estimated copy time taken to copy data to a GPGPU memory, an estimated execution time of the operation using the GPGPU, and a second estimated copy time taken to copy an execution result of the operation to a memory of a host in the GPGPU memory.

When the available computation resource is the CPU and the GPGPU, the cost may include an estimated time taken to divide data, the larger value of estimated operation cost using the CPU for the data allocated to use the CPU and estimated operation cost using the GPGPU for data allocated to use the GPGPU, and an estimated result merging time taken to merge a result of the operation using the CPU and a result of the operation using the GPGPU.

The data division ratio may represent a ratio of data to be processed using the CPU in the computation resources of the heterogeneous computing environment among all data.

The operation providing module may provide an execution result merging operation to the query execution module and provide cost models for each operation to the query optimization module, other than the respective computation resource based operations.

The query execution module may call each operation from the operation providing module to execute the corresponding computation resource based operations on the data allocated to each computation resource of the plurality of computation resources, merge the respective computation resource based operation execution results and provide the merged results, and notify the computation resource management module of the end of use of the computation resource of the corresponding operation when the operation execution finishes its execution.

### BRIEF DESCRIPTION OF THE DRAWINGS

FIG. 1 is a diagram illustrating an architecture of a data management system according to an exemplary embodiment of the present invention.

FIG. 2 is a diagram illustrating an architecture of a query processing unit according to an exemplary embodiment of the present invention.

FIG. 3 is a diagram illustrating an architecture of an operation providing module according to an exemplary embodiment of the present invention.

FIG. 4 is a flow chart of method for processing a query according to an exemplary embodiment of the present invention.

FIG. 5 is a flow chart illustrating a process of generating a query execution plan according to the exemplary embodiment of the present invention.

FIG. 6 is an exemplified diagram illustrating a process of obtaining an optimum data division ratio according to an exemplary embodiment of the present invention.

FIG. 7 is a flow chart illustrating a process of executing a query according to the exemplary embodiment of the present invention.

FIG. 8 is a diagram illustrating an example of an execution of a basic operation using heterogeneous computation resources in the method for processing a query according to the embodiment of the present invention.

FIG. 9 is a configuration diagram of another apparatus for processing a query according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, “comprising” any components will be understood to imply the inclusion of other elements rather than the exclusion of any other elements.

Hereinafter, a method and an apparatus for processing a query according to an exemplary embodiment of the present invention will be described.

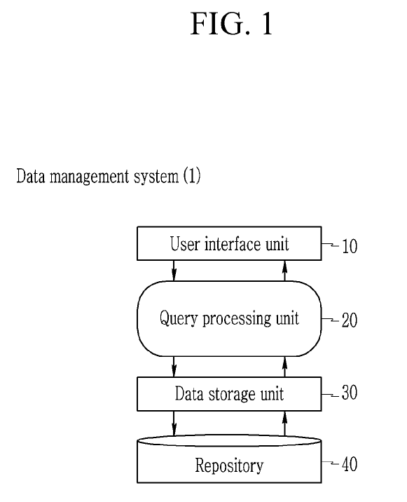

FIG. 1 is a diagram illustrating an architecture of a data management system according to an exemplary embodiment of the present invention.

Describing an exemplary embodiment of the present invention with reference to FIG. 1, a typical data management system 1 includes a user interface unit 10, a query processing unit 20, a data storage unit 30, and a repository 40.

The user interface unit 10 provides an interface so that a user can easily use the data management system. The user interface unit 10 may include a structured query language (SQL), a java database connectivity (JDBC) driver, an open database connectivity (ODBC) driver, a utility command, and the like.

The query processing unit 20 is configured to process a user request (query) transmitted through the user interface unit 10

The data storage unit 30 is configured to store and manage data in the repository 40. The query processing unit 20 may access the data stored in the repository 40 by using the function provided by the data storage unit 30. The repository 40 is physical repositories such as a dynamic random access memory (DRAM), a solid state disk (SSD), and a hard disk drive (HDD).

In the data management system 1, the query processing unit 20 generally performs an analysis on the semantics and syntax of a query statement (string) corresponding to an input user request to convert the query statement into a parse tree, draws up an optimal execution plan for the parse tree, and executes a query using a series of operation calls based on the execution plan and returns the results to the user.

According to the exemplary embodiment of the present invention, a query is processed using all of heterogeneous computing devices available for query processing in computer (or computing) environment consisting of the heterogeneous computing devices. Hereinafter, for convenience of explanation, the computer (or computing) environment consisting of the heterogeneous computing devices represents a computer (or computing) including a central processing unit (CPU) and a general-purpose computing on GPUs (GPGPUs) that are computing devices, but the present invention is not limited thereto. Further, for convenience of explanation, the CPU and GPGPU are also referred to as computation resources and are also referred to as heterogeneous computation resources (it may represent computation resources in the heterogeneous computation environment) including the CPU and the GPGPU.

The query processing unit 20 according to the embodiment of the present invention has the following structure.

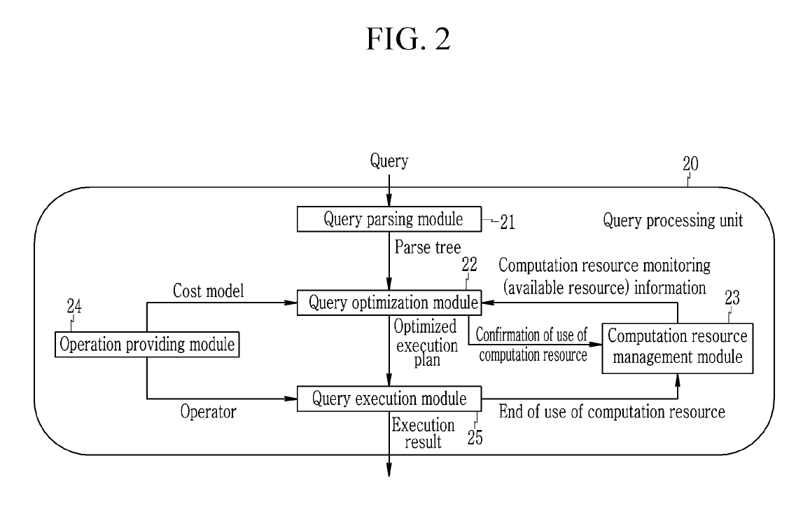

FIG. 2 is a diagram illustrating an architecture of a query processing unit according to an exemplary embodiment of the present invention.

Referring to FIG. 2, the query processing unit 20 according to the embodiment of the present invention includes a query parsing module 21, a query optimization module 22, a computation resource management module 23, an operation providing module 24, and a query execution module 25.

The query parsing module 21 is configured to perform the analysis on the semantics and syntax of the query statement corresponding to the user request input through the user interface 10 to convert the query statement into the parse tree.

The computation resource management module 23 is configured to perform management, monitoring and resource scheduling (allocation) on heterogeneous computation resources including the CPU and the GPGPU. The computation resource management module 23 provides computation resource monitoring information, that is, information on available computation resources that may perform the operation to the query optimization module 22 so that the heterogeneous computation resources may be efficiently used based on a load.

The operation providing module 24 is configured to provide a basic operation using the CPU and the GPGPU, which are heterogeneous computing devices and an execution result merging operation and provide a cost model for each operation.

The query optimization module 22 uses the cost model of the operation provided by the operation providing module 24 and the computation resource monitoring information provided by the computation resource management module 23 to generate an optimal execution plan for a query. Generating the optimal execution plan means deciding an execution order and a method of an operation configuring a query to provide a quick query response to a user. The query optimization module 22 determines not only in what order the operations required for the query are executed, but also how (e.g., CPU based hash join) to execute the operation (for example, join). Conventionally, in deciding how to perform the operations, considerations on the heterogeneous computation resources are insufficient. In other words, conventionally, only one computation resource is considered to execute the operation for query. However, the query optimization module 22 according to the embodiment of the present invention generates the optimal query execution plan by using all the available resources by considering the heterogeneous computation resources and a resource utilization rate. The generated query execution plan includes a plan for how to execute the operation configuring the query. For example, the query execution plan includes information about data to which the operations are to be applied, computation resources to execute the operations, an operation execution method, a data division ratio, and the like, for each operation.

The query execution module 25 is configured to execute the query using the series of operation calls to generate results, based on the optimal execution plan generated by the query optimization module 22. The query execution module 25 constructs the query execution environment and executes the query using the operation for the query processing provided from the operation providing module 24 based on the optimal query execution plan. And it also controls the query execution. Further, if necessary, the query execution module 25 serves to move data to a device (GPGPU) memory from host memory after dividing the data according to the query execution plan or transfers the execution result of the GPGPU-based operation to a memory of a host.

Meanwhile, according to the embodiment of the present invention, the query optimization module 22 decides the query execution plan by using the computation resource monitoring information provided by the computation resource management module 23 and if the computation resources to be used for the operation execution configuring the query according to the operation execution method of the query execution plan are set, notifies the computation resource management module 23 of the use of the corresponding computation resource and if the execution of query finished, the query execution module 25 notifies the computation resource management module 23 that the use of the computation resources ends.

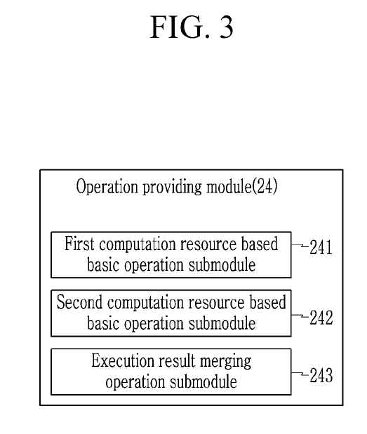

Meanwhile, the operation providing module 24 of the query processing unit 20 has the architecture as illustrated in FIG. 3 in order to effectively provide the operation for the query processing in the computing system consisting of the heterogeneous computation resources.

FIG. 3 is a diagram illustrating the architecture of the operation providing module 24 according to the exemplary embodiment of the present invention.

As illustrated in FIG. 3, the operation providing module 24 according to the embodiment of the present invention includes a first resource based basic operation submodule 241, a second resource based basic operation submodule 242, and an execution result merging operation submodule 243

The first resource based basic operation submodule 241 is configured to provide basic operations (e.g., a sort, a hash table) configuring an operation (e.g., join) for the query processing using the first computation resource, for example, the CPU.

The second resource based basic operation submodule 242 is configured to provide a basic operation configuring the operation for the query processing using a second computation resource, for example, the GPGPU.

The execution result merging operation submodule 243 is configured to merge results of the first computation resource based operation and results of the second computation resource based operation to generate one result.

Here, the architecture of the operation providing module 24 is described, by way of example, based on the computing environment in which the heterogeneous computation resources include the CPU and the GPGPU, but the present invention is not limited thereto and when the heterogeneous computation resources consist of three or more computation resources rather than two computation resources, other resource based basic operation submodules 241 and 242 may be added to the operation providing module 24 in addition to the first and second resource based basic operation submodules 241 and 242.

The query processing unit 20 having the structure may also be referred to as an apparatus for processing a query.

Next, a method for processing a query according to an embodiment of the present invention will be described based on the above-described architecture (components).

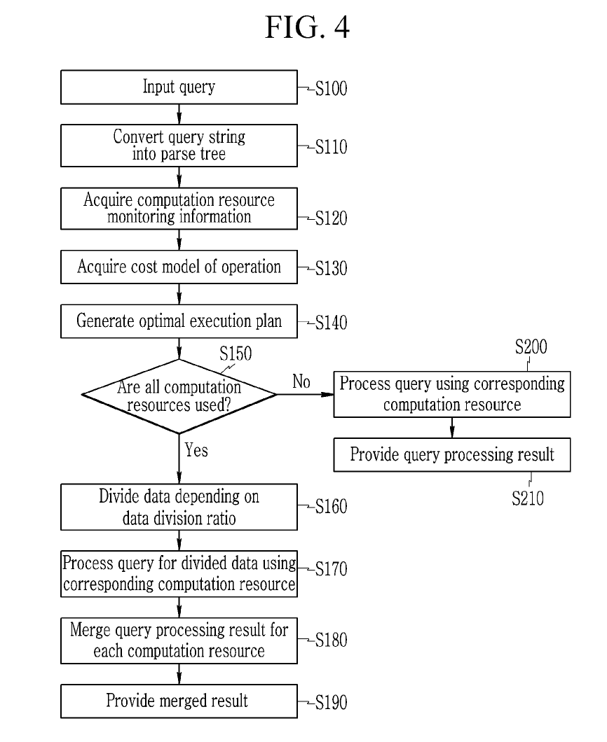

FIG. 4 is a flow chart of method for processing a query according to an exemplary embodiment of the present invention.

If the query statement corresponding to the user request is input, the query processing unit 20 performs the analysis on the semantics and syntax of the query statement to convert the query statement into the parse tree (S100 and S110). Thereafter, the query processing unit 20 performs the computation resource monitoring to acquire the information on the available computation resources that may currently perform the current operation (S120).

The query processing unit 20 acquires the cost model for the operation (S130), and generates the optimal execution plan for the corresponding query using the acquired cost model and the computation resource monitoring information, and in particular, generates the optimal query execution plan using all the available computation resources, in consideration of the heterogeneous computation resources and the resource utilization rate (S140). The query processing unit 20 decides an operation execution method having the minimum cost according to available computation resource conditions. At this point, an optimal query execution plan is generated in consideration of the division ratio of data to be processed by each computation resource included in the heterogeneous computing environment.

Next, if the computation resources to be used for the operation execution configuring the query based on the operation execution method according to the generated query execution plan are all the computation resources (S150), that is, if the computation resources to be used are both the CPU and the GUGPU, the query processing unit 20 divides the data corresponding to the input query depending on the data division ratio for each computation resource (S160). The data division ratio represents a ratio of data to be processed by the CPU among whole the data, and for example, has a value between 0.0 and 1.0. Setting the value of the data division ratio OPd to be 1.0 indicates that all the data are processed by the CPU and setting the value of the data division ratio OPd to be 0.0 indicates that there is no data to be processed by the CPU

The query processing unit 20 processes the divided data based on the corresponding computation resource based operation (S170).

When the query processing for each computation resource is completed, the query processing unit 20 merges the query processing results for each computation resource (S180) and provides the merged query processing results (S190). The query processing results may be provided to the user through the user interface 10.

Meanwhile, if the computation resources to be used for the operation execution is not all the computation resources but a specific resource (S150), the query processing unit 20 processes the data corresponding to the query based on the corresponding computation resource based operation (S200). Further, the query processing results are provided (S210).

Next, in the method for processing a query as described above, the process of generating an optimal query execution plan will be described in more detail.

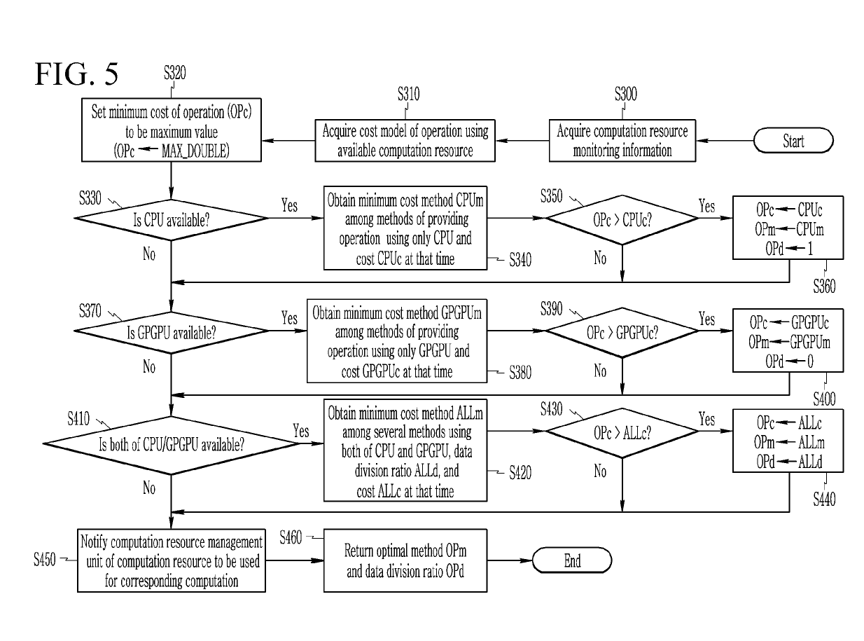

FIG. 5 is a flow chart illustrating a process of generating a query execution plan according to the exemplary embodiment of the present invention.

To decide in what order the operation required for the query is executed and how to execute the operation, as illustrated in FIG. 5, the query optimization module 22 of the query processing unit 20 receives information about the operation and information about the data to which the operation is to be applied. The information on the data to which the operation is to be applied includes a data size, index information, and the like.

The query optimization module 22 receives the computation resource monitoring information that is the information on the computation resources available for the operation execution from the computation resource management module 23 (S300). In addition, the query optimization module 22 receives the cost model of the operation using the available computation resources from the operation providing module 24 (S310).

In order to find the optimal method for executing the operation, the query optimization module 22 sets a minimum cost OP_{c} of the operation that is a parameter for determining the operation execution method as an initial value, for example, a maximum value MAX_DOUBLE (S320). Further, the minimum cost OP_{c} and the method OPₘ with minimum cost are obtained for the operation execution using the operation cost model according to the available computation resource.

Specifically, the query optimization module 22 determines whether the first computation resource, that is, the CPU is available using the computation resource monitoring information (S330). If the CPU is available, a method CPUₘ with minimum cost is found among several methods implemented to use the CUP for the corresponding operation. The cost at that time is called the minimum cost CPU_{c} using only a CPU.

Next, the minimum cost OP_{c} to the present is compared with the minimum cost CPU_{c} using only a CPU (S350). If the minimum cost CPU, using only a CPU is smaller than the minimum cost OP_{c} to the present, the optimum method OPₘ is set as the method CPUₘ of using only a CPU and the minimum cost OP_{c} is set as a value of the minimum cost CPU_{c} using only a CPU, and sets the data division ratio OP_{d} to be 1.0 (S360). Meanwhile, if the minimum cost CPU_{c} using only a CPU is greater than or equal to the minimum cost OP_{c} to the present, the optimal method OPₘ and the minimum cost OP_{c} remain unchanged.

Further, it is determined whether the GPCPU that is the second computation resource is available using the computation resource monitoring information (S370). If the GPGPU is available, a method GPGPUₘ with minimum cost is found among several methods implemented to use the GPGPU for the corresponding operation. The cost at that time is called the minimum cost GPGPU_{c} using only a GPGPU (S380).

The minimum cost OP_{c} to the present is compared with the minimum cost GPGPU_{c} using only a GPGPU (S390). If the minimum cost GPGPU_{c} using only a GPGPU is smaller than the minimum cost OP_{c} to the present, the optimum method OPₘ is set as the method GPGPUₘ of using only a GPGPU and the minimum cost OP_{c} is set as the minimum cost GPGPU_{c} using only a GPGPU, and sets the data division ratio OP_{d} to be 0.0 (S400). On the other hand, if the minimum cost GPGPU_{c} using only a GPGPU is greater than or equal to the minimum cost OP_{c} to the present, the optimal method OPₘ and the minimum cost OP_{c} remain unchanged.

In addition, it is determined whether both the CPU that is the first calculation resource and the GPCPU, which is the second calculation resource are available using the computation resource monitoring information (S410). If both of the CPU and the GPCPU are available, a data division ratio ALL_{d} and a method ALLₘ at the time of the minimum cost are found among several methods implemented to use both the CPU and the GPGPU for the corresponding operation. The costs at that time is called the minimum cost ALL_{c} using both the CPU and the GPGPU for the corresponding operation (S420). The minimum cost method ALLₘ among the methods implemented to use both of a CPU and a GPGPU is referred to as a method of using both of a CPU and a GPGPU and the cost at that time is the minimum cost ALL_{c} using both of a CPU and a GPGPU, and data division ratio ALL_{d} when cost is minimized among several methods implemented to use both of the CPU and the GPGPU is referred to as a data division ratio of the method of using both of a CPU and a GPGPU.

The minimum cost OP_{c} to the present is compared with the minimum cost ALL_{c} using both of a CPU and a GPGPU (S390). If the minimum cost ALL_{c} using both of a CPU and a GPGPU is smaller than the minimum cost OP_{c} to the present, the optimal method OPₘ is set as the method ALLₘ of using both of a CPU and a GPGPU and the minimum cost OP_{c} is set to be a value of the minimum cost ALL_{c} using both of a CPU and a GPGPU. Further, the data division ratio OP_{d} is set as the data division ratio ALL_{d} using both of a CPU and a GPGPU (S440).

By the process, the minimum cost method OPₘ, that is, the optimal method for the operation execution may be found among several methods implemented to use the computation resource(s) available for the corresponding operation depending on the computation resources available for the operation execution, for the predetermined operation configuring the query.

Hereinafter, the query optimization module 22 notifies the computation resource management module 23 of the computation resources (CPU and/or GUGPU) to be used for the operation according to the optimal method OPₘ for the operation execution (S450) and returns the optimal method OPₘ and the optimal data division ratio OP_{d} (S460). The optimal method OPₘ, that is, the operation execution method and the optimal data division ratio OP_{d} are provided to the query execution module 25.

In the process of generating the query execution plan, a method of cost computation will be described. In order to find the optimal method for performing an operation, the cost computation for selecting the optimal operator is performed. The cost may include estimated execution time, estimated power usage, etc., but in the exemplary embodiment of the present invention, for convenience of explanation, a method of performing cost computation based on the assumption that cost includes the estimated execution time will be described. However, the present invention is not limited thereto.

The cost of the method of using only a CPU, that is, CPU based operation cost C_{cpu} may be represented as follows as the estimated execution time E_{cpu} of the operation using the CPU.

C_{cpu}=E_{cpu} (Equation 1)

Further, the cost of the method of using only a GPGPU, that is, the GPGPU based operation cost C_{gpu} includes a time Dᵢₙₚᵤₜ (which may be called a first copying time) to copy data to a GPGPU memory space, the estimated operation execution time E_{gpu} using the GPGPU, and a time Dᵣₑₛᵤₗₜ (which may be called a second copying time) to copy the result to the memory of the host and may be represented as follows.

C_{gpu}=Dᵢₙₚᵤₜ+E_{gpu}+Dᵣₑₛᵤₗₜ (Equation 2)

In addition, the cost of the method using both of a CPU and a GPGPU, that is, cost C_{all,p} of the operation based on which the CPU processes as much as a ratio p of the input data by using both of the CPU and the GPGPU and the GPGPU processes the rest includes a time S taken to divide data, the larger value of operation cost C_{cpu,p} using the CPU for data allocated to use the CPU and operation cost C_{gpu,(1-p)} using the GPGPU for the data allocated to use the GPGPU and a result merging estimated time (M), and may be represented as follows.

C_{all,p}=S+MAX(C_{cpu,p}, C_{gpu,(1-p)}+M (Equation 3)

Here, C_{all,p} is cost when a ratio of data to be processed by the CPU among all the data is p.

Meanwhile, in the process of finding an optimal method for executing an operation, the cost of using both the CPU and the GPGPU may vary depending on the data division ratio. That is, since the cost Cₐₗₗ of the operation is changed depending on the ratio p processed by the CPU, and therefore the minimum cost among the changed costs needs to be obtained, which is represented by the following Equation.

Cₐₗₗ=MIN(C_{all,p}) for all p where 0.0<=p<=1.0 (Equation 4)

The computation of the estimated cost for obtaining the optimal data division ratio may be a burden, and therefore it is possible to obtain the optimal data division ratio while reducing the range to a specific ratio (cost computation search range reduction ratio r, reduction ratio r for short) based on a modified binary search technique, not computing and comparing the estimated cost for all the p values. According to the exemplary embodiment of the present invention, the reduction ratio r may be changed from operation to operation and is provided while being included in the cost model of the operation. That is, a method for obtaining and comparing estimated costs when a data division ratio is 0.0 and 1.0 and then applying a reduction ratio r to a data division ratio with large estimated cost to shift the data division ratio by a predetermined value to thereby compare cost at the time of reducing a search range with low cost is continuously applied.

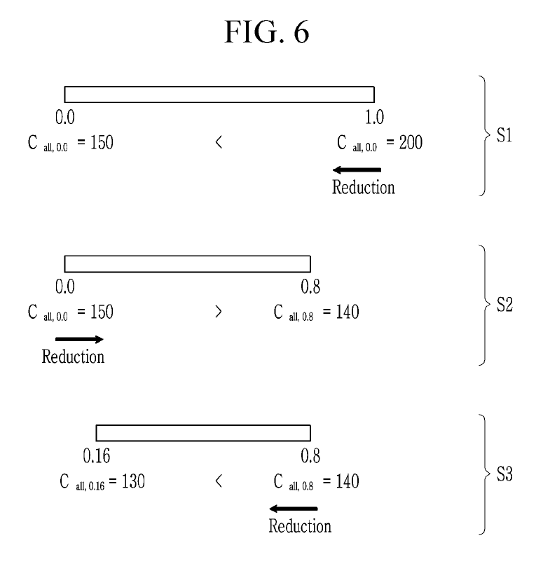

FIG. 6 is an exemplified diagram illustrating a process of obtaining an optimum data division ratio according to an exemplary embodiment of the present invention.

Here, it is assumed that the reduction ratio r is “0.4”. As illustrated in FIG. 6, first, the estimated costs C_{all,0.0} and C_{all,1.0} when the data division ratio is 0.0 and 1.0 are each obtained in search intervals 0.0 and 1.0 for obtaining the optimal data division ratio and compared. As the comparison result, the G_{all,1.0} is larger, and therefore the data division ratio 1.0 having the larger estimated cost is shifted toward an intermediate value by the shift value (S1).

The intermediate value represents the intermediate value of the data division ratios (e.g., 0.0 and 1.0) that configures the search interval. The shift value is a value calculated by applying the reduction ratio r to the search interval and may be calculated depending on “shift value=first data split ratio±(first data split ratio+second data split ratio)/2×r)”. Here, the first data division ratio represents a data division ratio having the larger estimated cost among the data division ratios configuring the search interval and the second data division ratio represents the data division ratio having the smaller estimated cost among the data division ratios configuring the search interval. ±becomes “+” or “−” depending on the shift direction.

In the step S1, the shift value in the search intervals (0.0 and 1.0) is 0.2 (=1.0−(0.0+1.0)/2×0.4). The data division ratio 1.0 having the larger estimated cost is shifted toward the intermediate value depending on the shift value 0.2. As the result, the search interval becomes 0.0 and 0.8.

Hereinafter, in new search intervals (0.0 and 0.8), the estimated costs C_{all,0.0} and C_{all,0.8} when the data division ratio is 0.0 and 0.8 are obtained and compared. C_{all,0.0} is larger, and therefore the data division ratio 0.0 having the larger estimated cost is shifted toward the intermediate value by a shift value (0.16=0.0+(0.0+0.8)/2.×0.4) (S2). As the result, the search interval becomes 0.16 and 0.8 (S3).

The process is repeated until the values of the search interval meet each other, and the value of the optimum ratio p having the minimum cost is obtained. The ratio p thus obtained is used as the data division ratio.

Next, in the method for processing a query as described above, the query processing process using the operation will be described in more detail

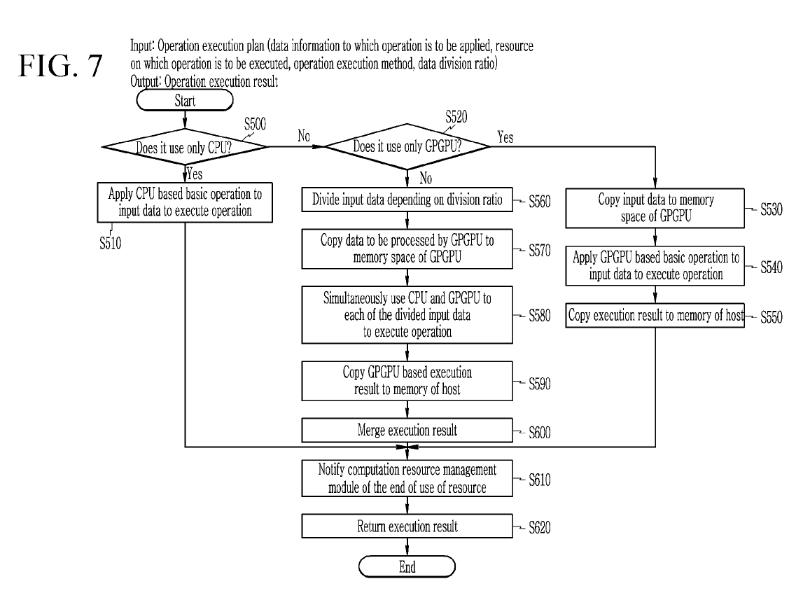

FIG. 7 is a flow chart illustrating a process of executing a query according to the exemplary embodiment of the present invention.

The query execution plan generated by the query optimization module 22 and provided to the query execution module 25 includes a plan for how to execute the operation configuring the query for each operation. The query execution module 25 executes the operation by referring to the query execution plan. The query execution plan includes information about data to which the operations are to be applied, computation resources to execute the operations, an operation execution method, a data division ratio, and the like, for each operation.

The query execution module 25 executes the operation based on the query execution plan which was generated by the query optimization module 22. Specifically, as illustrated in FIG. 7, the query execution module 25 determines whether the corresponding operation is an operation executed by using only the CPU that is a first computation resource (S500) and if the operation is an operation using only the CPU, executes the operation by applying the CPU based basic operation to the input data (S510).

It is determined whether the corresponding operation is an operation executed using only the GPGPU that is the second computation resource (S520), and thus if the operation is the operation using only the GPGPU, the input data are copied to the GPGPU memory (S530) and then the GPGPU-based basic operation is applied to execute the operation (S540) and the execution results are copied to the memory of the host (S550).

If the execution is planned so that the corresponding operation is executed using all the heterogeneous computation resources, the input data are divided according to the data division ratio (S560) and the CPU based basic operation and the GPGPU based basic operation are simultaneously used for each of the divided input data to execute the operation. Specifically, the data to which the GPGPU based basic operation is applied are copied to the GPGPU memory (S570), and the CPU based basic operation and the GPGPU based basic operation are each executed for each of the divided input data to execute the operation (S580) and the operation execution results are copied to the memory of the host (S590). Next, the query execution module 25 merges the CPU based basic operation execution results with the GPGPU based basic operation execution results to generate the execution results of the operation (S600).

The query execution module 25 notifies the computation resource management module 23 of the end of use of the computation resource in all the cases where the execution results of the operation are generated (S610) and then returns the execution results (S620) and ends. The execution results are provided to the user.

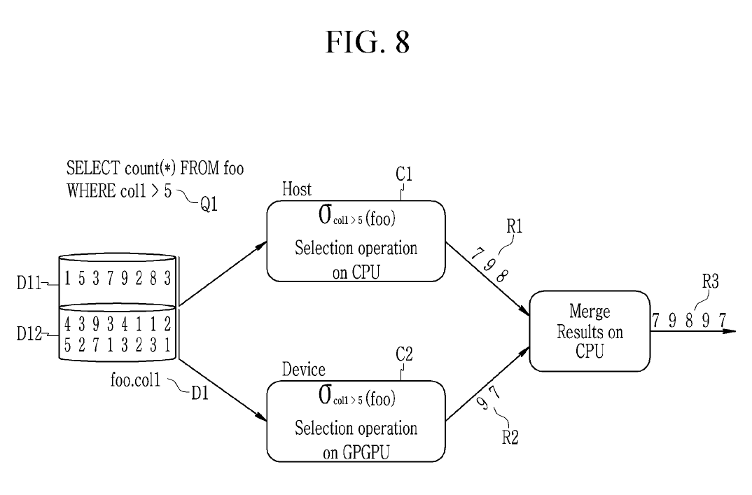

FIG. 8 is a diagram illustrating an example of an execution of a basic operation using heterogeneous computation resources in the method for processing a query according to the embodiment of the present invention.

In order to describe the execution of the basic operation for processing the query using the heterogeneous computation resources according to the embodiment of the present invention, as illustrated in FIG. 8, it is assumed that there is query Q1 obtaining the number of rows in which a value of a predetermined column col1 of a table (foo) is greater than 5. As the query processing basic operation configuring the query, the operation of selecting the case where the value of the column col1 is larger than 5 is included.

In order to process the query using the heterogeneous computation resources according to the exemplary embodiment of the present invention, a data D1 is divided depending on the data division ratio specified in the optimal query execution plan and a data D12 to be processed by the GPGPU is copied to the memory space of the GPGPU. A data D11 to be processed by the CPU is provided to the memory space of the host.

The CPU and the GPGPU are each simultaneously used for the data divided as described above to select a row satisfying a filtering condition. That is, the data D11 allocated to be processed by the CPU and the data D12 allocated to be processed by the GPGPU are each processed by a selection operation C1 that the first computation resource based basic operation submodule 241 provides and a selection operation C2 that the second computation resource based basic operation submodule 242 provides. The respective processing results R1 and R2 are merged by the execution result merging operation submodule 243 responsible for merging, and thus a final processing result R3 is provided.

Conventionally, for all data D1 to be processed, only one of the CPU and the GPGPU is used to execute the selection operation. In this case, another computation resource is not used. However, according to the exemplary embodiment of the present invention, the selection operation may be executed using all the available computation resources. Therefore, the query response time may be decreased and the resource utilization rate may be increased.

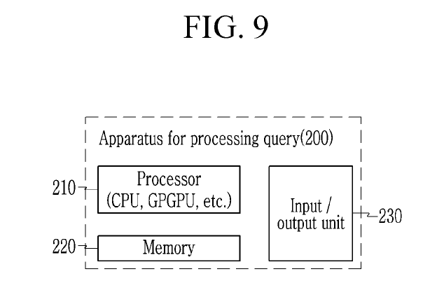

FIG. 9 is a configuration diagram of another apparatus for processing a query according to an exemplary embodiment of the present invention.

As illustrated in FIG. 9, an apparatus 200 for processing a query according to the exemplary embodiment of the present invention includes a processor 210, a memory 200, and an input/output unit 230. The processor 210 may include all the heterogeneous computing devices such as the CPU and the GPGPU and may be configured to implement the methods described with reference to FIGS. 2 to 7. For example, the processor 210 may be configured to execute the functions of the query parsing module, the query optimization module, the computation resource management module, the operation providing module, and the query execution module.

The memory 220 is connected to the processor 210 and stores various information associated with an operation of the processor 210. The memory may store instructions for operations to be executed by the processor 210 or load instructions from a storage apparatus (not illustrated) and temporarily store the loaded instructions.

The processor 210 may execute the instructions stored or loaded in the memory 220. The processor 210 and the memory 220 are connected to each other through a bus (not illustrated) and an input/output interface (not illustrated) may also be connected to the bus.

The input/output unit 230 is configured to output the processed results of the processor 210 and receive the query and the data corresponding thereto and provide the received data to the processor 210.

According to the exemplary embodiment of the present invention, it is possible to decrease the response time to the query processing request of the user and increase the resource utilization rate and the throughput of the system by using all of the heterogeneous computing devices for the query processing in the computing environment including the heterogeneous computing devices.

In addition, it is possible to perform the efficient query processing by processing the query by the method for consuming the minimum cost among the methods of using some or all of the heterogeneous computing devices.

The exemplary embodiments of the present invention are not implemented only by the apparatus and/or method as described above, but may be implemented by programs realizing the functions corresponding to the configuration of the exemplary embodiments of the present invention or a recording medium recorded with the programs, which may be readily implemented by a person having ordinary skill in the art to which the present invention pertains from the description of the foregoing exemplary embodiments.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for processing, by an apparatus for processing a query, an input query, comprising:
generating, by the apparatus for processing a query, an optimal query execution plan for processing the query using all of a plurality of computation resources included in a heterogeneous computation resource;
dividing data corresponding to the query depending on a data division ration included in the query execution plan and allocating the divided data to each computation resource; and
processing the divided data based on each computation resource.

2. The method of claim 1, wherein:
the query execution plan includes a computation resource on which an operation is to be executed, an operation execution method, and the data division ratio, for each operation configuring a query and further includes data information to which the operation is to be applied.

3. The method of claim 1, wherein:
the generating of the optimal query execution plan includes:
determining a method to execute operation with minimum cost among a plurality of methods which are implemented to use a computation resource available for the operation according to an available computation resource for the plurality of computation resources.

4. The method of claim 3, wherein:
the determining of the operation execution method includes:
determining the method to execute operation with minimum cost among the plurality of methods which are implemented to use one computation resource, when the available computation resource is one; and
determining the method to execute operation with minimum cost the plurality of methods which are implemented to use at least two computation resources, when the available computation resource is two or more.

5. The method of claim 4, wherein:
when the available computation resources are CPUs and GPGPUs, the cost includes a time taken to divide data, the larger value of operation cost using the CPU for the data allocated to use the CPU and operation cost using the GPGPU for data allocated to use the GPGPU, and a result merging estimated time taken to merge a result of the operation using the CPU and a result of the operation using the GPGPU.

6. The method of claim 1, wherein:
in the generating of the query execution plan,
an optimal query execution plan is generated in consideration of the division ratio of data to be processed by each computation resource included in the heterogeneous computing environment.

7. The method of claim 6, wherein:
the data division ratio represents a ratio of data to be processed using a CPU in the heterogeneous computing environment among all data.

8. The method of claim 6, wherein:
when the computation resources in the heterogeneous computation environment include a CPU and other computation resources other than the CPU and use all the CPU and the other computation resources,
the generating of the query execution plan further includes:
obtaining an optimal data division ratio having a minimum operation cost.

9. The method of claim 8, wherein:
the obtaining of the optimal data division ratio includes:
a first step of comparing an estimated cost of a first data division ratio and an estimated cost of a second data division ratio, for a search interval consisting of the first data division ratio and the second data division ratio;
a second step of shifting a data division ratio having a larger estimated cost toward an intermediate value by a shift value to reduce the search interval, among the first data division ratio and the second data division ratio, as the comparison result; and
a third step of obtaining the optimal data division ratio having a minimum operation cost by repeatedly performing the first step and the second step for the reduced search interval.

10. The method of claim 9, wherein:
the shift value is calculated depending on the following Equation.
Shift value=first data division ratio±(first data division ratio+second data division ratio)/2×r)
r represents a reduction ratio, the first data division ratio represents a data division ratio having a larger estimated operation execution cost among the data division ratios configuring the search interval, and the second data division ratio represents a data division ratio having a less estimated operation execution cost among the data division ratios configuring the search interval.

11. The method of claim 10, wherein:
the reduction ratio r has different value for each operation.

12. The method of claim 1, wherein:
the processing includes:
executing each of the corresponding computation resource based operations on data allocated to each computation resource of the plurality of computation resources;
merging the respective computation resource based operation execution results; and
providing the merged operation execution results as a query processing result.

13. An apparatus for processing a query, comprising:
an input/output unit configured to receive a query and data corresponding thereto; and
a processor connected to the input/output unit and executing the query processing,
wherein the processor includes:
a query optimization module configured to generate an optimal query execution plan for processing the query using all of a plurality of computation resources included in heterogeneous computation environment, the optimal query execution plan including a data division ratio dividing data corresponding to the query and allocating the divided data to each computation resource;
an operation providing module configured to provide each of the computation resource based operations; and
a query execution module configured to call any computation resource based operation of the operation providing module according to the query execution plan and execute the corresponding operation based on data allocated to the computation resource of the called operation.

14. The apparatus of claim 13, wherein:
the query execution plan includes a computation resource on which an operation is to be executed, an operation execution method, and the data division ratio, for each operation configuring a query and further includes data information to which the operation is to be applied.

15. The apparatus of claim 13, wherein:
the query optimization module
determines to execute operation with minimum cost among a plurality of methods which are implemented to use a computation resource available for the operation according to an available computation resource condition for the plurality of computation resources.

16. The apparatus of claim 15, wherein the query optimization module estimates the cost of operation based on a cost model provided by the operation providing module.

17. The apparatus of claim 16, wherein:
when the available computation resource is a CPU, the cost is an estimated execution time of the operation using the CPU,
when the available computation resource is a GPGPU, the cost includes a first estimated copy time taken to copy data to a GPGPU memory, an estimated execution time of the operation using the GPGPU, and a second estimated copy time taken to copy an execution result of the operation to a memory of a host in the GPGPU memory, and
when the available computation resource is the CPU and the GPGPU, the cost includes an estimated time taken to divide data, the larger value of estimated operation cost using the CPU for the data allocated to use the CPU and operation cost using the GPGPU for data allocated to use the GPGPU, and an estimated result merging time taken to merge a result of the operation using the CPU and a result of the operation using the GPGPU.

18. The apparatus of claim 13, wherein:
the data division ratio represents a ratio of data to be processed using a CPU in the computation resources of the heterogeneous computing environment among all data.

19. The apparatus of claim 13, wherein:
the operation providing module
provides an execution result merging operation to the query execution module and provides cost models for each operation to the query optimization module, other than the respective computation resource based operations.

20. The apparatus of claim 19, wherein:
the query execution module
calls each operation from the operation providing module to execute the corresponding computation resource based operations on the data allocated to each computation resource of the plurality of computation resources, merges the respective computation resource based operation execution results and provides the merged results, and notifies the computation resource management module of the end of use of the computation resource of the corresponding operation when the operation execution finishes its execution.
